(19) United States
(12) Patent Application Publication
(10) Pub. No.: US 2009/0045561 A1
(43) Pub. Date: Feb. 19, 2009

(54) PRESSURIZED FLUID OPERATED SOLID FRICTION SHOCK ABSORBER

(76) Inventor: Carvalho Neto Lincoln De Miranda, Sera (BR)

Correspondence Address: DARBY & DARBY P.C., P.O. BOX 770, Church Street Station, New York, NY, 10008-0770, US

(21) Appl. No.: 11/914,514

(22) PCT Filed: May 16, 2006
(86) PCT No.: PCT/BR06/00100

§ 371 Date: Jun. 11, 2008

(30) Foreign Application Priority Data
May 16, 2005 (BR) PI0501661-4

(51) Int. Cl. B60G 13/04

(52) U.S. Cl. 267/205

(57) ABSTRACT

Solid friction shock absorber operated by a pressurized fluid which enables the quick dissipation, through solid friction, of the elastic energy absorbed by vehicles' suspensions. The pressurized bag presses the brake pads with brake linings against the inner wall of the body, creating a solid friction which dissipates the elastic energy absorbed. The pressurized fluid bag and the brake linings are installed on the shaft by presses. The pressurized fluid bag is fed by a feeder tube, a pressurized disk, or by a compressor.

This invention refers to a solid friction shock absorber operated by a pressurized fluid which will enable quick dissipation, through solid friction, of the elastic energy absorbed by vehicles' suspensions.

The function of the shock absorber is to avoid oscillations and undesirable movement of the suspension, keeping the wheels in firm contact with the ground the whole time, thus allowing greater stability, better driving and braking capability of the vehicle.

Two basic concepts exist as for the friction type, being them: Viscous friction, dissipates the elastic energy through the friction of a hydraulic oil flowing through galleries and internal valves of the hydraulic shock absorber; Solid friction, dissipates the elastic energy through the friction among two rigid surfaces tightly pressed against each other by springs.

The hydraulic shock absorber became, practically, the only available option in the market, due to its reasonable cost when manufactured in large scale, its good operational efficiency and appropriate dimensions for several types of applications.

The spring operated solid friction shock absorber is used in very specific and restricted applications, having high weight due to the need of all the components to be designed to endure the great strains produced by the springs; efficiency loss due to the loss of elasticity of the spring and wear and tear of the pads with time; tuning difficulty due to the great pressure of the spring, that demands special devices and is potentially dangerous; high cost due to difficulties in the production and in the assembly; and being impracticable for use in light vehicles such as automobiles and motorcycles.

The main advantages of pressurized fluid operated solid friction shock-absorbers are the ease of production, done by cold stamping, plastic injection, rubber vulcanizing, some or no machining at all; simple concept, robust and with few parts; efficiency, because it doesn't need maintenance until the end of the life time; and versatility, because a single model can be used in a great range of situations just by adjusting the working pressure.

With the intent of solving the aforementioned problems of the spring operated solid friction shock absorber, the pressurized fluid operated solid friction shock absorber of was developed, and will be described in according to the attached illustrations, being that:

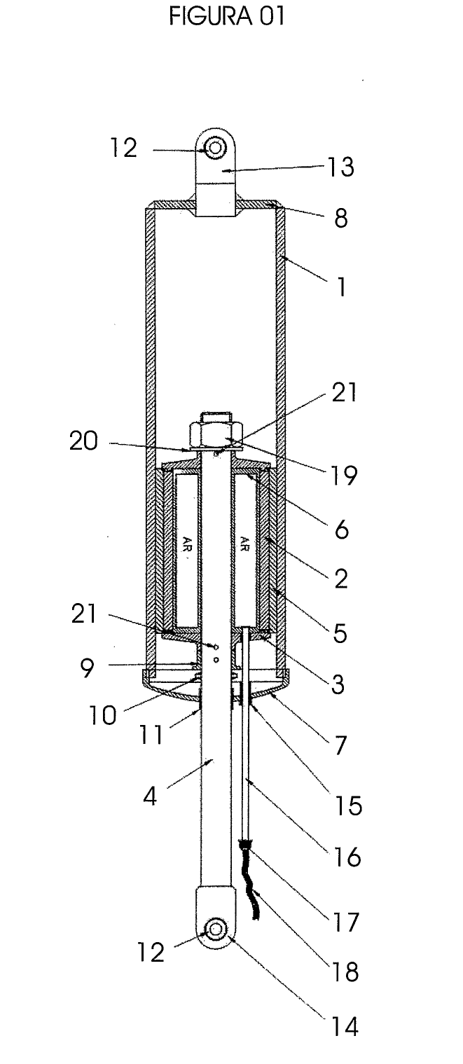

FIG. 01 presents the lateral cut of the pressurized fluid operated solid friction shock absorber;

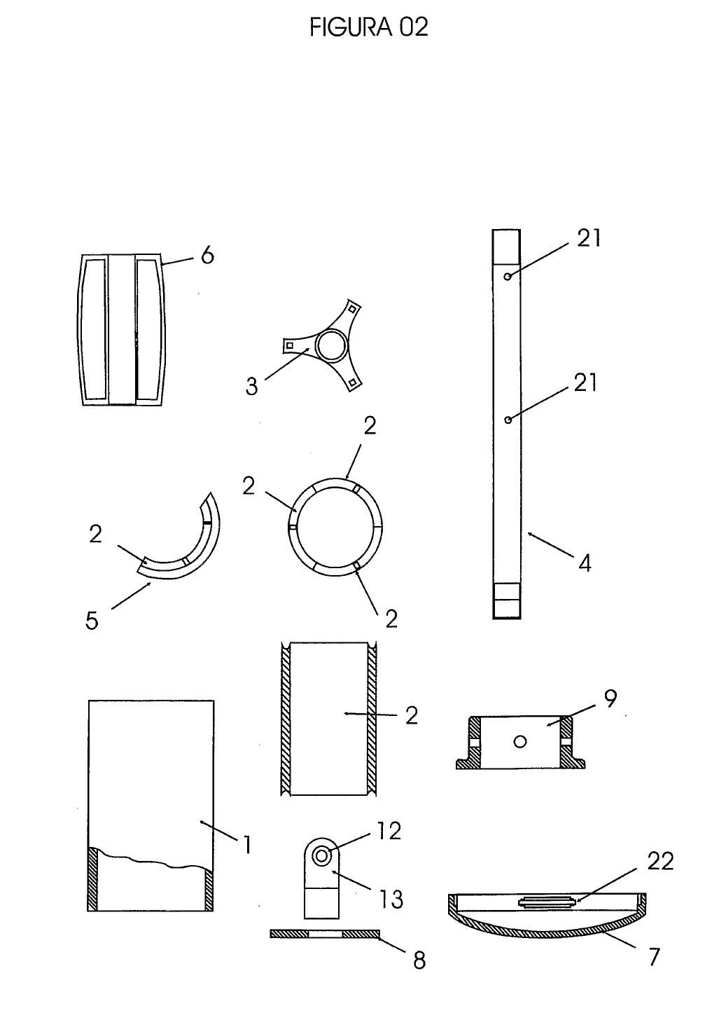

FIG. 02 presents the technical drawing of the component parts of the pressurized fluid operated solid friction shock absorber.

As it can be observed in the illustrations, the pressurized fluid operated solid friction shock absorber works through a rubber bag of pressurized fluid (6), fed externally by a feeder tube (16) and connected the a hose (18) by a hose adapter (17), which presses three brake shoes (2) with brake linings (5) against the inner wall of the shell (1) of the shock absorber, establishing a force normal to the contact surface between the brake shoe's (2) brake lining (5) and the inner wall of the shell (1). The pressurized fluid bag (6) can be feed by a flask pressurized with the fluid, installed on the shock absorber, or by a compressor, if the vehicle or facility has one.

The brake shoes (2) are mounted on two grippers (3) through fittings, female on the brake shoes (2) and male on the grippers (3), so that they will allow the radial displacement of the brake shoes (2), and compensate the eventual wear and tear of the brake lining (5). The pressurized fluid bag (6) follows the movement of the brake shoes (2), automatically adjusting itself to all the new positions, because it is elastic.

The grippers (3) are firmly mounted onto the shaft (4), of cylindrical shape and with screw threads on both ends, through a fast clamp with restraint pin (21) and the whole group of pressurized fluid bag (6), brake shoes (2), brake linings (5) and grippers (3) will move together with the shaft (4). The movement of the group above described in contact with the inner wall of the shell (1,) due to the fluid pressure in the bag of pressurized fluid (6), will create the solid friction forces that will dissipate the absorbed elastic energy.

The shell (1) has a primary cover (7) with internal screw threads, gasket channel (22), guide tube (11) for the shaft (4) and guide adapter (15) for the feeder tube (16). It also has a secondary cover (8) to which a mount (13) with rubber cushion (12) is attached.

The shaft (4) has, attached to the end external to the shell (1), a shaft mount (14) with rubber cushion (12) and, fastened to the end internal to the shell (1), a six-sided DIN 934 CL 5.6 nut (19) and a DIN 127 pressure washer that will improve the fastening of the grippers (3). The shaft (4) has a stopper (9) with restraint pin (21), juxtaposed to the gripper (3) closest to the primary cover (7), and a gasket (10) attached to the primary cover (7) through the gasket channel (22).

The pressurized fluid operated solid friction shock absorber will have great applicability in the automotive industry, filling all of the requirements and industrial applicability inherent to the patent grant.

1-5. (canceled)

6. A shock absorber for a vehicle having a suspension and a frame, comprising:
a shell coupled to the frame of the vehicle, the shell having a center and a first friction surface on an inner surface of the shell;
a slidable member disposed next to the first friction surface, the slidable member having a first major surface and a second major surface, the second major surface comprising a second friction surface opposed to the first friction surface, wherein the second friction surface is slidably coupled to the first friction surface, and the first major surface facing the center of the shell;
a coupling member configured to couple the slidable member to the suspension of the vehicle; and
a hydraulic actuator configured to apply a pressure to press the second friction surface against the first friction surface, wherein the pressure applied by the hydraulic means increases the friction.

7. The shock absorber of claim 6, wherein the hydraulic actuator comprises:
an expandable fluid bag, disposed next to the first major surface, having an opening to allow passage of fluid;
a feeder tube having a first end and a second end, the first end attached to the opening of the fluid bag; and
a hose having a distal end and a proximal end, the distal end comprising a hose adapter coupled to the second end of the feeder tube, allowing passage of a fluid,
wherein passage of the fluid through the hose and feeder tube into the expandable fluid bag expands the fluid bag, causing an increase in the pressure of the second friction surface against the first friction surface.

8. The shock absorber of claim 6, wherein the coupling member comprises:
a shaft comprising a first threaded end portion and a second threaded end portion;
a first restraint pin transverse to, and extending through, a longitudinal axis of the shaft, the first restraint pin being located at an approximate middle of the shaft;
a second restraint pin transverse to, and extending through, a longitudinal axis of the shaft, the second restraint pin being located between the first restraint pin and the first threaded end portion;
a nut engaging the first threaded end portion of the shaft;
a cylindrical stopper having a transverse opening encircling the shaft, the transverse opening engaging with the second restraint pin;
a shaft mount disposed around the second threaded end portion and coupled to the suspension of the vehicle;
a first gripper comprising a plurality of arms extending radially from a central aperture, the first gripper fitted around the shaft between the first restraint pin and the second restraint pin, wherein the plurality of arms contacts a first longitudinal end of the slidable member; and
a second gripper comprising a plurality of arms extending radially from a central aperture, the second gripper fitted around the shaft between first gripper and the first restraint pin, wherein the plurality of arms of the second gripper contacts a second longitudinal end of the slidable member.

9. The shock absorber of claim 6, wherein the shell further comprises:
a cylindrical body having a first longitudinal end and a second longitudinal end;
a primary cover fitting over the second longitudinal end of the cylindrical body;
a gasket channel forming a first opening through the center of the primary cover;
a guide tube fitted through the first opening;
a feeder tube channel forming a second opening through the primary cover; and
a guide adapter fitted through the second opening.

10. The shock absorber of claim 9, wherein the shell further comprises:
a secondary cover covering the first longitudinal end of the shell; and
a mount attached to the first longitudinal end of the secondary cover,
wherein the mount is adapted to attach the shell to the frame of the vehicle.
